(19) United States
(12) Patent Application Publication
(10) Pub. No.: US 2026/0236794 A1
(43) Pub. Date: Aug. 13, 2026

(54) SYSTEMS AND METHODS FOR TRAINING MACHINE LEARNING MODELS USING FORWARD VELOCITIES

(71) Applicant: MASTERCARD INTERNATIONAL INCORPORATED, Purchase, NY (US)

(72) Inventors: Arun Kanthali, Dewas (IN); Christopher John Merz, Wildwood, MO (US); Deepak Bhatt, O'Fallon, MO (US); Joshua A. Allbright, Chesterfield, MO (US); Maneet Singh, New Delhi (IN)

(21) Appl. No.: 19/050,904

(22) Filed: Feb. 11, 2025

(51) Int. Cl. G06N 5/022; G06Q 20/40

(52) U.S. Cl. CPC G06N 5/022; G06Q 20/4016

(57) ABSTRACT

A computer system for labeling anomalous data for re-training a scoring machine-learning model is provided. The computer system includes a processor programmed to: receive transaction data associated with a plurality of declined transactions; apply a scoring model to the transaction data for the plurality of declined transactions; rank the plurality of declined transactions from low probability to high probability of fraud; apply a labeling model to the transaction data of a set of the plurality of declined transactions, the set including a batch of the declined transactions having higher probability scores assigned thereto; generate, using the labeling model, a precision percentage for the set of the plurality of declined transactions representing a ratio of the declined transactions labeled as fraud by the labeling model relative to the total number of declined transactions included in the set of declined transactions; and refine the precision percentage by examining subsets of the set.

### BACKGROUND

The field of the disclosure relates generally to creating machine learning models using forward velocities and, more particularly, to systems and methods for training and applying machine learning models using forward velocities to more accurately label data for use in building other models.

Machine learning (ML) is a field of study within artificial intelligence (AI) that involves the development and study of statistical algorithms that can be used to effectively perform tasks without explicit instructions on how to do it. For example, a machine learning model may be trained using historical data that enables the model to recognize patterns within the data and outputs resulting from those patterns. Thus, when the model is trained and applied to new data that is inputted into the model, the model is able to recognize those same patterns and predict an output based on the outputs from the historical data. Of course, in order to build the models that are subsequently used in the machine learning tools, one must have good data that is properly labeled. Without quality data having accurate labeling, the models that are trained and built will be unable to accurately predict outcomes when applied to new data.

ML can be applied and used in many areas and industry segments. It has been applied to large language models, computer vision, speech recognition, email filtering, agriculture, medicine, insurance, and the financial or payment industry. For example, in the payment industry, most payment transactions are performed at a merchant, either in a store or via a website, using a payment card (e.g., a credit card, a debit card, or some other account to account mechanism). The payment card may be used at a point-of-sale (POS) device within a store, or in an online transaction through e-commerce, or at an ATM, to initiate payment for the purchase of goods/services, and/or for cash withdrawal. In these transactions, an electronic request message is typically sent from the POS, the ATM, and/or the e-commerce system to a bank (referenced herein as an acquirer bank) associated with the POS, the ATM, and/or the e-commerce system to initiate the transaction. The acquirer bank may then generate and send an electronic authorization request message over a payment network that is managed by a payment processor to an issuer bank that issued the payment card to the cardholder. The issuer bank reviews the authorization request message and performs a lookup to see if the account associated with the payment card and the cardholder has sufficient funds to cover the purchase of the good or services. If the account has sufficient funds to cover the purchase, the issuer bank sends back an authorization response message that includes an approval response for the purchase. If, however, the account does not have sufficient funds to cover the purchase, then an authorization response message that includes a decline response is sent.

In some cases, payment networks and/or an issuer bank may use authentication tools to help prevent fraudulent transactions (e.g., fraud in a card-not-present (CNP) transactions, and so on). Various authentication tools may be used for trying to detect fraud in CNP transactions. These authentication tools may be used to help decline or deny a transaction due to the transaction being considered high risk for fraud. Thus, the authorization response message may also decline a transaction for fraud purposes or for failure to have sufficient funds. In some cases, the authorization response message from the issuer may include a reason code if the financial transaction is declined.

In some cases, the reason code for a declined payment transaction may identify a particular category and a reason for which the financial transaction is declined. For example, a reason code 51 may suggest that the financial transaction is declined due to financial reasons such as insufficient funds, or the financial transaction is over the credit limit. Reason codes 14, 54, and 78 may indicate that the financial transaction is being declined due to account-related issues such as an invalid card number, an expired card, and/or an invalid or a non-existent account number. When a financial transaction is declined due to policy reasons, a reason code 65 may be used to suggest that the financial transaction exceeds a withdrawal count limit, a reason code 75 may be used to indicate an allowable number of PIN attempts are exceeded, and a reason code 62 may be used to suggest that the card is restricted. A financial transaction may be declined for security reasons, and reasons codes 04, 43, and 55 identify security reasons for which the financial transaction may be declined. The reason code 04 may suggest that the card is a captured card. The reason code 43 may suggest that the card is a stolen card, and the reason code 55 may suggest that an invalid PIN is used. The financial transaction may be declined due technical reasons, and reason codes 80 and 30 may be used to suggest a network error and a format error, respectively. A reason code 15 may suggest an invalid issuer. In some cases, there may be more than one reason for denying a transaction.

Because the payment network may also build fraud detection models for analyzing payment transactions, it is important to know the correct reason and all potential reasons for an issuer to decline a transaction. In many cases, the reason codes that may be provided by the issuer in the authorization response message do not provide a complete or accurate indication as to whether the transaction at issue is fraudulent. For example, a transaction that is declined by the issuer for insufficient funds may also be a fraudulent transaction, and thus, the authorization message from the issuer which may only show the insufficient funds reason code would not show fraud being a reason at all. Thus, if these transactions were used to build a new model for detecting fraud, the mislabeling of it as just an insufficient funds decline would negatively impact the accuracy of the new model.

Accordingly, it is important to accurately label data for building future models. It is also important to examine transactions that have been declined to determine if any of those transaction is also fraudulent. Accurate labels need to be applied to these declined transactions just like accurate labels are needed for approved transactions. Therefore, there is a need to have methods and systems to identify fraudulent transactions from declined transactions to improve the building of models for more accurately detecting future fraudulent transactions and approval of genuine financial transactions.

### BRIEF DESCRIPTION

In one aspect, a computer system for labeling anomalous data for re-training a scoring machine-learning model is provided. The computer system includes a machine learning module comprising a labeling model for analyzing and labeling data, a memory for storing computer-executable instructions, and at least one processor in communication with the memory and the machine learning module, when the computer-executable instructions are executed, the at least one processor is programmed to: (i) receive transaction data associated with a plurality of declined transactions, at least some of the plurality of declined transactions being labeled as fraudulent; (ii) apply a scoring model to the transaction data for the plurality of declined transactions, the scoring model outputting a probability score for each declined transaction indicating a likelihood that the corresponding declined transaction is fraudulent; (iii) rank the plurality of declined transactions using the probability scores from low probability of fraud to high probability of fraud; (iv) apply the labeling model to the transaction data of a set of the plurality of declined transactions, the set including a batch of the declined transactions having higher probability scores assigned thereto as compared to the remainder of the plurality of declined transactions; (v) generate, using the labeling model, a precision percentage for the set of the plurality of declined transactions, the precision percentage representing a ratio of the declined transactions labeled as fraud by the labeling model relative to the total number of declined transactions included in the set of declined transactions; (vi) identify one or more subsets of declined transactions within the set of declined transactions; (vii) generate a precision percentage for each of the one or more subsets of declined transactions; (viii) select the subset of the set of declined transactions having the highest corresponding precision percentage assigned thereto; and (ix) identify the selected subset of declined transactions as a re-training subset of fraudulent transactions for re-training the scoring model.

In another aspect, a computer-implemented method for labeling anomalous data for re-training a scoring machine-learning model is provided. The method includes (i) receiving transaction data associated with a plurality of declined transactions, at least some of the plurality of declined transactions being labeled as fraudulent; (ii) applying a scoring model to the transaction data for the plurality of declined transactions, the scoring model outputting a probability score for each declined transaction indicating a likelihood that the corresponding declined transaction is fraudulent; (iii) ranking the plurality of declined transactions using the probability scores from low probability of fraud to high probability of fraud; (iv) applying a labeling model to the transaction data of a set of the plurality of declined transactions, the set including a batch of the declined transactions having higher probability scores assigned thereto as compared to the remainder of the plurality of declined transactions; (v) generating, using the labeling model, a precision percentage for the set of the plurality of declined transactions, the precision percentage representing a ratio of the declined transactions labeled as fraud by the labeling model relative to the total number of declined transactions included in the set of declined transactions; (vi) identifying one or more subsets of declined transactions within the set of declined transactions; (vii) generating a precision percentage for each of the one or more subsets of declined transactions; (viii) selecting the subset of the set of declined transactions having the highest corresponding precision percentage assigned thereto; and (ix) identifying the selected subset of declined transactions as a re-training subset of fraudulent transactions for re-training the scoring model.

In another aspect, at least one non-transitory computer-readable storage medium that includes computer-executable instructions embodied thereon is provided. When the computer-executable instructions are executed by at least one processor, the computer-executable instructions cause the at least one processor to: (i) receive transaction data associated with a plurality of declined transactions, at least some of the plurality of declined transactions being labeled as fraudulent; (ii) apply a scoring model to the transaction data for the plurality of declined transactions, the scoring model outputting a probability score for each declined transaction indicating a likelihood that the corresponding declined transaction is fraudulent; (iii) rank the plurality of declined transactions using the probability scores from low probability of fraud to high probability of fraud; (iv) apply the labeling model to the transaction data of a set of the plurality of declined transactions, the set including a batch of the declined transactions having higher probability scores assigned thereto as compared to the remainder of the plurality of declined transactions; (v) generate, using the labeling model, a precision percentage for the set of the plurality of declined transactions, the precision percentage representing a ratio of the declined transactions labeled as fraud by the labeling model relative to the total number of declined transactions included in the set of declined transactions; (vi) identify one or more subsets of declined transactions within the set of declined transactions; (vii) generate a precision percentage for each of the one or more subsets of declined transactions; (viii) select the subset of the set of declined transactions having the highest corresponding precision percentage assigned thereto; and (ix) identify the selected subset of declined transactions as a re-training subset of fraudulent transactions for re-training the scoring model.

In one aspect, a computer system including a machine learning module for building machine learning models is disclosed. The machine learning module is configured to detect anomalous data within transaction data. The computer system further includes a memory and at least one processor in communication with the memory. The memory stores instructions, which are executable to cause the at least one processor to: (i) receive data associated with a plurality of declined transactions, a subset of the plurality of declined transactions being labeled as fraudulent transactions; (ii) train a machine-learning model using the received data associated with the plurality of declined transactions; (iii) determine a number of batches of declined transactions of the plurality of declined transactions; (iv) generate a probability score for each declined transaction of each batch of the declined transactions; and (v) based on the probability score for each declined transaction of each batch of declined transactions, identify and label a specific number of declined transactions in each batch of the declined transaction as fraudulent transactions. The specific number of declined transactions corresponds with a number of fraudulent transactions in the subset of the plurality of declined transactions and the number of batches of declined transactions.

In another aspect, a computer-implemented method using a machine learning module for building machine learning models configured to detect anomalous data within transaction data. The computer-implemented method includes (i) receiving data associated with a plurality of declined transactions, a subset of the plurality of declined transactions being labeled as fraudulent transactions; (ii) training a machine-learning model using the received data associated with the plurality of declined transactions; (iii) determining a number of batches of declined transactions of the plurality of declined transactions; (iv) generating a probability score for each declined transaction of each batch of the declined transactions; and (v) based on the probability score for each declined transaction of each batch of declined transactions, identifying and labeling a specific number of declined transactions in each batch of the declined transaction as fraudulent transactions. The specific number of declined transactions corresponds with a number of fraudulent transactions in the subset of the plurality of declined transactions and the number of batches of declined transactions.

In yet another aspect, at least one non-transitory computer-readable storage medium including computer-executable instructions embodied thereon is disclosed. The computer-executable instructions are executed by at least one processor of an interchange network computer including a machine learning module for building machine learning models configured to detect anomalous data within transaction data. The computer-executable instructions cause the at least one processor to (i) receive data associated with a plurality of declined transactions, a subset of the plurality of declined transactions being labeled as fraudulent transactions; (ii) train a machine-learning model using the received data associated with the plurality of declined transactions; (iii) determine a number of batches of declined transactions of the plurality of declined transactions; (iv) generate a probability score for each declined transaction of each batch of the declined transactions; and (v) based on the probability score for each declined transaction of each batch of declined transactions, identify and label a specific number of declined transactions in each batch of the declined transaction as fraudulent transactions. The specific number of declined transactions corresponds with a number of fraudulent transactions in the subset of the plurality of declined transactions and the number of batches of declined transactions.

### BRIEF DESCRIPTION OF THE DRAWINGS

FIG. 1 is a schematic diagram illustrating an example multi-party payment card industry system for enabling payment transactions between merchants, issuers and cardholders in accordance with the present disclosure.

FIG. 2 is a block diagram of an example computer system representative of a fraudulent transaction identification service computer system in the payment processing environment shown in FIG. 1.

FIG. 3 illustrates an example configuration of a cardholder computer system operated by a cardholder shown in FIG. 1.

FIG. 4 illustrates an example configuration of the server computer system shown in FIGS. 1 and 2.

FIG. 5 is an example flow diagram of labeling precision by tree-based models.

FIG. 6 is a schematic diagram of an exemplary server computing device that may be used with the system shown in FIG. 2.

FIG. 7 is a diagram illustrating a risk gradient for transactions showing transactions scored using a scoring model for likelihood of fraud from a low likelihood to a high likelihood in accordance with the present disclosure.

FIG. 8 is a diagram showing a timeline of transactions initiated using a payment card that include several transactions leading up to a likely fraud event and several transactions initiated after.

FIG. 9 is a flow diagram of an example method of identifying fraudulent transactions from the declined transaction, which may be implemented by the computer system shown in FIG. 4.

### DETAILED DESCRIPTION OF THE DISCLOSURE

The following detailed description illustrates embodiments of the disclosure by way of example and not by way of limitation. It is contemplated that the systems and processes described herein have general application to the aspect of processing payment card transactions. More specifically, the embodiments of the systems and methods described herein relate generally to identifying and accurately labeling a payment transaction that has been declined for a variety of potential reasons from among a plurality of declined transactions as a fraudulent transaction. The transactions thus labeled as fraudulent transactions are then used for training one or more machine-learning (ML) algorithms for identifying future fraudulent transactions and denying authorization requests for those fraudulent transactions.

Described in detail herein are example embodiments of systems and methods for identifying and accurately labeling a declined transaction as a fraudulent transaction using one or more ML algorithms. In particular, the ML algorithms described herein and used in the present disclosure are more accurate in identifying fraudulent transactions from the declined transactions without requiring more computational resources. Additionally, or alternatively, the ML algorithms described herein may more effectively retrain the models using an updated database in comparison with a rule-based system for identifying fraudulent transactions among the declined transactions. The ML algorithms described herein generate a probability score for each declined transactions suggesting how likely a declined transaction may be a fraudulent transaction. Accordingly, in comparison with a rule-based system for identifying fraudulent transactions among declined transactions, the ML algorithms-based system using the probability score provide more flexibility over the rule-based system that is binary in nature (e.g., identifying a declined transaction as a 100% fraudulent transaction or 0% fraudulent transaction). The ML algorithms described in the present disclosure use concepts of forward velocities in identifying declined transactions that should be labeled as fraudulent transactions. The use of forward transaction velocities improve the precision in identifying these fraudulent transactions among the declined transactions.

More specifically, the system described herein includes a computer system for labeling anomalous data for re-training a scoring machine-learning model. In the example embodiment, the computer system includes a machine learning module having a labeling model for analyzing and labeling data, a memory for storing computer-executable instructions, and at least one processor in communication with the memory and the machine learning module. When the computer-executable instructions are executed, the at least one processor is programmed to: (i) receive transaction data associated with a plurality of declined transactions, at least some of the plurality of declined transactions being labeled as fraudulent; (ii) apply a scoring model to the transaction data for the plurality of declined transactions, the scoring model outputting a probability score for each declined transaction indicating a likelihood that the corresponding declined transaction is fraudulent; (iii) rank the plurality of declined transactions using the probability scores from low probability of fraud to high probability of fraud, (iv) apply the labeling model to the transaction data of a set of the plurality of declined transactions, the set including a batch of the declined transactions having higher probability scores assigned thereto as compared to the remainder of the plurality of declined transactions; (v) generate, using the labeling model, a precision percentage for the set of the plurality of declined transactions, the precision percentage representing a ratio of the declined transactions labeled as fraud by the labeling model relative to the total number of declined transactions included in the set of declined transactions; (vi) identify one or more subsets of declined transactions within the set of declined transactions; (vii) generate a precision percentage for each of the one or more subsets of declined transactions; (viii) select the subset of the set of declined transactions having the highest corresponding precision percentage assigned thereto, and (ix) identify the selected subset of declined transactions as a re-training subset of fraudulent transactions for re-training the scoring model.

In another embodiment, the computer system further includes instructions that further cause the at least one processor to apply the labeling model to the transaction data of a set of the plurality of declined transactions, wherein the labeling model is trained using historical transaction data for a plurality of account identifiers included in the plurality of declined transactions, and wherein the transaction data for each account identifier of a declined transaction includes transaction data associated with a plurality of transactions initiated prior to the declined transaction and a plurality of transactions subsequent to the declined transactions.

In another embodiment, the transaction data includes transaction data associated with a plurality of transactions initiated prior to the declined transaction including prior transaction velocities including decision intelligence scoring data.

In another embodiment, the transaction data includes transaction data associated with a plurality of transactions initiated subsequent to the declined transaction including forward transaction velocities, wherein the forward transaction velocities are associated with transactions initiated between 1 minute and 24 hours following the declined transaction. This additional transaction data from the forward transactions provides additional insights into whether the declined transaction is fraudulent or not.

In another embodiment, the computer system further includes instructions that cause the at least one processor to train the machine-learning scoring model using at least one of (i) a decision tree approach including extreme gradient boosting (XGB) based decision trees, and/or (ii) a plurality of forward transaction velocity features.

In another embodiment, the computer system further includes instructions that cause the at least one processor to generate the probability score using a plurality of fraud detection models and transaction data for each account identifier of a declined transaction including transaction data associated with a plurality of transactions initiated prior to the declined transaction and a plurality of transactions subsequent to the declined transactions.

In another embodiment, the computer system further includes a plurality of fraud detection models wherein each model is trained using one or more attributes of declined transactions including transaction level attributes including, but not limited to, an account identifier, a merchant category code (MCC), or a merchant name.

In another embodiment, a plurality of fraud detection models is used. Each fraud detection model is trained using one or more attributes of declined transactions including transaction level attributes including, but not limited to, an authorized amount, or a number of declined transactions, etc.

In another embodiment, the computer system analyzes transactions initiated subsequent to each decline transaction being reviewed. These subsequent transaction may be initiated between 1 minute and 24 hours after the declined transaction. These forward velocities are analyzed to improve the AI models.

In another embodiment, the computer system further includes instructions that cause the at least one processor to re-train the scoring model using the selected subset of declined transactions labeled as fraudulent transactions to update and improve the accuracy of the scoring model.

The methods and systems described herein may be implemented using computer programming or engineering techniques including computer software, firmware, hardware or any combination or subset thereof, wherein the technical effect may be achieved by performing at least one of the following steps: (a) leverage machine learning tools to identify and accurately label payment transactions, such as payment transactions that have been declined for a variety of potential reasons from among a plurality of declined transactions as a fraudulent transaction; (b) train, re-train, and/or update one or more machine learning algorithms and/or tools for identifying future fraudulent transactions and denying authorization requests for those fraudulent transactions; (c) accurate identification of fraudulent transactions from declined transactions without requiring more computational resources; (d) conservation of significant amounts of human and computational resources; (e) utilization of forward velocities in identifying declined transactions that should be labeled as fraudulent transactions, including improving the precision in identifying such fraudulent transactions among the declined transactions via the forward velocities; (f) reduce processing required for determining, scoring, and/or labeling fraudulent transactions; (g) ability to analyze a wide variety of parameters and dimensions in connection with payments such as credit card-based payments; (h) create and utilize machine learning models such as a labeling model for analyzing and labeling data, and a scoring model outputting a probability score for declined transactions, for indicating a likelihood that a given declined transaction is fraudulent; (i) rank declined transactions using probability scores from low probability of fraud to high probability of fraud; and/or (j) generate a precision percentage for a set of declined transactions, the precision percentage representing a ratio of declined transactions labeled as fraud by a labeling model relative to the total number of declined transactions included in a set of declined transactions. More generally, a technical effect of the systems and methods described herein is improvements in leveraging technology such as machine learning tools and/or other intelligence-based rules to improve the speed and accuracy of the scoring and labeling of transactions such as payment transactions made via a payment card. The methods and systems described herein may be implemented using computer programming or engineering techniques including computer software, firmware, hardware, or any combination or subset thereof.

As used herein, an acquiring bank or acquirer is typically a bank (or financial institution) at which a merchant holds an account. Further, an issuing bank or issuer (or financial institution) is typically a bank at which a customer or cardholder holds an account. The account may be debited or charged through the use of a debit card, a credit card, or another type of payment card as described herein.

As used herein, the terms “payment card,” “financial transaction card,” and “transaction card” refer to any suitable payment card, such as a credit card, a debit card, a prepaid card, a charge card, a membership card, a promotional card, a frequent flyer card, an identification card, a gift card, and/or any other device that may hold payment account data, such as mobile phones, smartphones, smart cards, digital wallets, personal digital assistants (PDAs), key fobs, and/or computers. Each type of payment card can be used as a method of payment for performing a transaction. In addition, cardholder account behavior can include but is not limited to purchases, management activities (e.g., balance checking), bill payments, achievement of targets (meeting account balance goals, paying bills on time), and/or product registrations (e.g., mobile application downloads).

As used herein, the term “home payment network” and related terms (e.g., “home network”) refers to a first payment processing network where a cardholder initiates a payment card transaction with a merchant. Entities within the home payment network may include the cardholder, the issuer, the acquirer, the merchant and/or a home payment network. Any of the in-network entities may register for marketplace enrichment operations, as described in detail herein, provided by one or more off-network marketplace providers that are separate and distinct from any of the in-network entities included in the home payment network.

As used herein, the term “off-network parties” or “third parties” and related terms (e.g., “off-network”) may refer to a party that is outside of or separate from a home payment network that provides enrichment services outside of the home network or that is different from in-network entities of the home payment network where the payment card transaction is originated. As used herein, off-network third party marketplace or ecosystem providers are capable of receiving marketplace operation requests from one or more home entities within the home payment network and providing and/or applying marketplace enrichment operations for payment card transactions originating in the home payment network by home entities who registered for the marketplace operations. The marketplace provider may apply the marketplace enrichment operation to the payment transaction. The term applying, as it relates to a marketplace operation, is a generic term describing execution of the marketplace operation or execution of further enrichment processing of the transaction message that provides additional value-added services to the requestor and/or the cardholder. For example, applying a marketplace operation may refer to enriching data contained within the payment transaction, such as adding additional data to the transaction message. In another example, applying a marketplace operation may refer to providing insurance coverage for an amount (full or partial) of the payment transaction in the event that the payment transaction is later determined to be fraudulent or if for some reason the merchant is unable to provide the product or service purchased. In some embodiments, the off-network marketplace providers are not financial institutions. The off-network marketplace providers may include, without limitation, a sales tax compliance institution, a duty tax compliance institution, a fintech institution, a receipt institution, a loyalty installment institution, a fraud detection institution, an insurance provider, or any suitable entity enabled to provide a marketplace operation to a payment transaction.

As used herein, the term “translation module” and related terms (e.g., “translation module system”) refers to a method of converting marketplace operation requests from a format used on the home payment network (e.g., by an issuer bank, an acquiring bank, and/or the merchant) to a format that may be read or processed by the off-network marketplace providers and vice versa. The translation module may include, without limitation, a data layout protocol, an algorithm for mapping service requests from the home payment network format to the marketplace provider format and vice versa, and an automated program that converts marketplace (referred to herein as initiating service request) service requests from the home payment network format to the marketplace provider format and vice versa. For example, a payment transaction, initiated on the home payment network may be transmitted in an ISO® 8583 compliant data message or ISO® 20022 compliant message. As used herein, “ISO®” refers to a series of standards approved by the International Organization for Standardization. (ISO is a registered trademark of the International Organization for Standardization of Geneva, Switzerland.) ISO® 8583 compliant messages are defined by the ISO® 8583 standard which governs financial transaction card originated messages and further defines acceptable message types, data elements, and code values associated with such financial transaction card originated messages. ISO® 8583 compliant messages include a plurality of specified locations or data fields for storing Private Data Elements. The translation module may reconfigure the ISO® 8583 compliant messages associated with a payment transaction initiated on the home payment network to the request message having a format acceptable and readable by parties not on the home payment network.

As used herein, the term “network processor” or “payment processor” and related terms (e.g., “home network processor”) refers to computer system(s) associated with a payment network that may be used to communicate data between computer systems associated with an issuer bank, a cardholder, a merchant, an acquirer bank, a payment aggregator, a payment gateway, a government, a financial technology (“Fintech”) system, and/or an account clearing house (“ACH”) system, and communicate with off-network computer system(s) that may be used to provide marketplace operations. Also, as used herein, the home network processor may be configured to receive marketplace operation requests from a requestor and send marketplace operation requests to the translation module or directly to the off-network marketplace or marketplace providers.

As used herein, the requestor is the person or entity within the home payment network that is requesting, or has registered, for the marketplace operation to be applied to a payment transaction. The requestor may sometimes be referred to as the marketplace operation recipient or an authorizing entity who authorizes the marketplace operation (e.g., the entity paying for the marketplace operation or on whose behalf the marketplace operation is being carried out). The requestor may be the creator and sender of a marketplace operation request based upon marketplace registration record or a payment transaction. Thus, the requestor may be at least one entity within the home network (e.g., the issuer, the merchant, the acquirer, or the cardholder who registers with the marketplace operation and receives the marketplace operation). The requestor may generate a first service request and use a translation module to translate or convert it to a second service request. Alternatively, another party within the home network, other than the requestor, may utilize the translation module to generate the service request, on behalf of the requestor. For example, the home payment network may generate the first service request and use either the requestor computer system translation module or the receiving ITS computer system translation module to translate or convert it to a second service request, on behalf of the requestor.

As used herein, a processor includes a programmable system including systems using microcontrollers, reduced instruction set circuits (RISC), application specific integrated circuits (ASICs), logic circuits, and any other circuit or processor capable of executing the functions described herein. The above examples are example only, and thus are not intended to limit the definition and/or meaning of the term “processor” in any way.

In one embodiment, computer-executable instructions are provided and are embodied on a non-transitory computer readable storage medium. The computer-executable instructions cause a computer executing the instructions to utilize a Structured Query Language (SQL) with a client user interface front-end for administration and a web interface for standard user inputs and reports. In an example embodiment, the system is web-enabled and is run on a business entity intranet. In an alternative embodiment, the system is fully accessible by individuals having authorized access from outside a firewall of the business-entity through the Internet. In a further alternative embodiment, the system is run in a Windows® environment (Windows is a registered trademark of Microsoft Corporation, Redmond, Wash.). The application is flexible and designed to run in various different environments without compromising any major functionality.

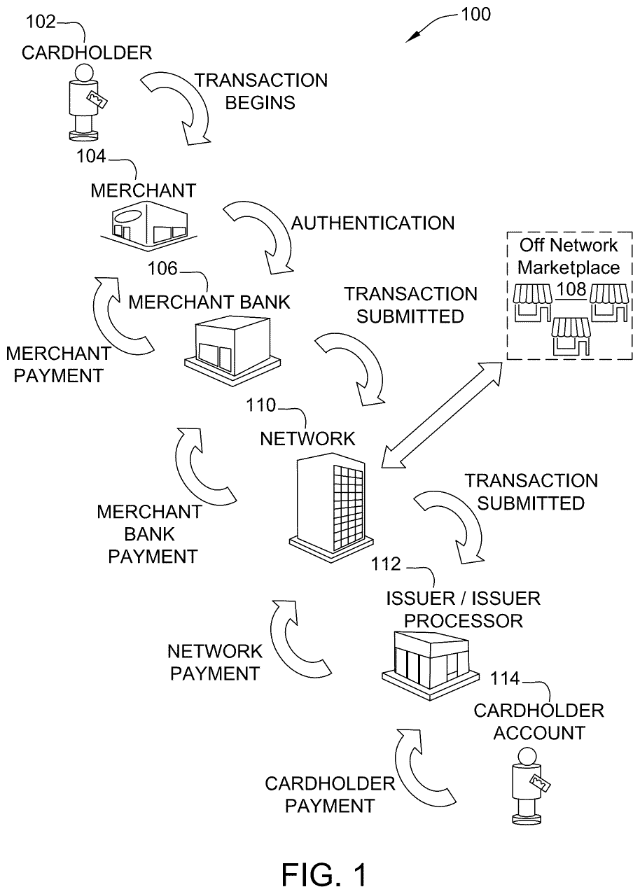

FIG. 1 is a schematic diagram illustrating an example multi-party payment processing network system 100 for enabling payment transactions between merchants 104 and card issuers 112. Embodiments described herein may relate to a payment card system, such as a credit card payment processing system using the Mastercard® interchange network (Mastercard is a registered trademark of Mastercard International Incorporated located in Purchase, New York). The Mastercard interchange network is a set of proprietary communications standards promulgated by Mastercard International Incorporated for the exchange of financial transaction data and the settlement of funds between financial institutions that are members of Mastercard International Incorporated.

In a typical payment card system, a financial institution called the “issuer” issues a payment card, such as a credit or debit card, to a consumer or cardholder 102, who uses the payment card to tender payment for a purchase from a merchant 104. To accept payment with the payment card, merchant 104 must normally establish an account with a financial institution that is part of the financial payment system. This financial institution is usually called the “merchant bank,” the “acquiring bank,” or the “acquirer,” such as a merchant bank 106. When cardholder 102 tenders payment for a purchase with a payment card, merchant 104 sends an authorization request message to merchant bank 106 for the amount of the purchase. The request may be performed over the telephone, but may be also performed through the use of a computer system having access to a website or app enabling input of cardholder's 102 account information, or the use of a point-of-sale device, which reads cardholder's 102 account data from a magnetic stripe, a chip, or embossed characters on the payment card and communicates electronically with the transaction processing computers of merchant bank 106. Alternatively, merchant bank 106 may authorize a third party to perform transaction processing on its behalf. In this case, the point-of-sale device will be configured to communicate with the other party. Such other party is usually called a “merchant processor,” an “acquiring processor,” or a “third party processor.”

The merchant bank 106 forwards the authorization request message to an interchange network 110. The interchange network 110 may use authentication products or tools to detect fraudulent transactions (e.g., fraud in a card-not-present (CNP) transaction, and so on). The authentication tools may be applied for both in-person transactions and/or card-not-present (CNP) transactions to detect fraudulent transactions. The interchange or payment processing network 110 may forward the authorization request with a DI (decision intelligence) score and/or a DTI score to issuer 112. The DI score may be an indicator or output of the analysis of the transaction data, namely whether the data indicates that the transaction is likely fraudulent or non-fraudulent. In many cases, these authentication tools require periodic updating to detect new forms of fraud or changes in data for existing types of fraud.

Issuer 112 may determine whether cardholder's 102 account 114 is in good standing and whether the purchase is covered by cardholder's 102 available credit limit or current funds in the cardholder account. Based on these determinations, the request for authorization will be responded to by the issuer with an authorization response message that includes either a decline response or an approved response. When the authorization request is approved, the authorization response message may include a reason code from issuer 112 as to the reason for approval. And when the authorization request is declined by issuer 112, a reason code may be included in the authorization response message from issuer 112 to interchange network 110 indicating a reason for declining the transaction.

In some embodiments, particularly where the messages are following an ISO protocol, the reason code for the declined transaction may identify a particular category and a reason for which the transaction is declined. However, as described herein, in many cases, the reason codes that may be provided by the issuer 112 in the authorization response message do not provide a complete or accurate indication as to whether the transaction at issue is fraudulent. For example, a transaction that is declined by the issuer 112 for insufficient funds may also be a fraudulent transaction, and thus, the authorization response message from the issuer 112 which may only show the insufficient funds reason code would not show fraud being a reason at all. Thus, if these transactions were used to build a new model for detecting fraud, the mislabeling of it as just an insufficient funds decline would negatively impact the accuracy of the new model.

However, the reason code provided in the authorization response message transmitted to interchange network 110 may not indicate whether the declined transaction is also fraudulent. For example, an authorization response message transmitted by the issuer 112 that declines a transaction for insufficient funds or an expired card number, etc., may not indicate whether the declined transaction was also likely initiated by a fraudulent actor. Thus, this declined transaction message may be mis-labeled as a legitimate transaction that just happened to be declined for insufficient funds if the reason code were used for labeling the transaction. Since the authorization requests are typically declined based on the risk models or fraud detection models used by the issuer 112, and as the more fraudulent transactions are identified by the issuer 112, the more fraudulent definitions (or patterns) of the fraudulent transactions may be added to a database of declined transactions (or fraudulent transactions) of the issuer 112. However, the interchange network 110 and/or the acquirer (or the merchant bank 106) may not be aware of these emerging fraud patterns. Thus, over time, the risk models that are used by the issuer 112 may improve, but the risk models developed by the merchant bank 106 and/or the interchange network 110 may not improve because of the mis-labeling of certain declined transactions which are then used for updating the models used by the merchant bank 106 and/or the interchange network 110. Accordingly, it is very important that the declined transactions have correct labels for those that are fraudulent transactions for at least the reason of updating these models for detecting future fraudulent transactions.

Further, in those cases where a declined transaction is labeled as a fraudulent transaction by the issuer 112, the models used are usually associated with the issuer 112 and not necessarily known by the processor or the merchant bank. The acquirer (or the merchant bank 106) may work with more than one issuer, and thus from one issuer to another issuer, depending on the risk models used by the issuer, the fraudulent transaction may be approved by one issuer but may be declined by another issuer. Accordingly, knowing fraud patterns to correctly identify the fraudulent transactions by the acquirer (or the merchant bank 106) and/or the interchange network 110 may help prevent fraudulent transactions being approved by one or more issuers. Further, a database of transactions labeled as fraudulent transactions may be provided as a product to the acquirer (or the merchant bank 106) by the interchange network 110, when the declined transactions are reviewed and labeled as fraudulent transactions as described herein using forward velocities concept.

Currently, transactions are identified as fraudulent transactions based on a declining labeling logic (DLL) based rules system in which a declined transaction is processed through the DLL based rules system and the declined transaction may be labeled as a fraudulent transaction or a genuine transaction. Additionally, or alternatively, a declined transaction may be unlabeled (or in other words, the declined transaction may not be identified as a fraudulent transaction or a genuine transaction). This is a very time consuming and person intensive process.

In one example, the DLL based rules system may mark a transaction as a fraudulent transaction and mark a merchant as a fraudulent merchant, if the declined transaction is transacted at a merchant where the card (e.g., the credit card or the debit card) was never transacted, or approved at, before. In another example, the DLL based rules system may label the declined transaction as a fraudulent transaction as an attempt from a potential fraudulent merchant within 2 or more days of a safe reported fraud from the same merchant. In yet another example, a merchant may be marked as a fraudulent merchant, and the declined transaction may be labeled as a fraudulent transaction when no transaction originated by a merchant has been approved during a specific period. Based on data available for declined transactions and transactions that are identified as fraudulent transactions using the DLL based rules system and the transactions being actually fraudulent, a precision of about 15% and a recall of about 5% may be obtained. As discussed below, the system and method described herein significantly improves on these metrics.

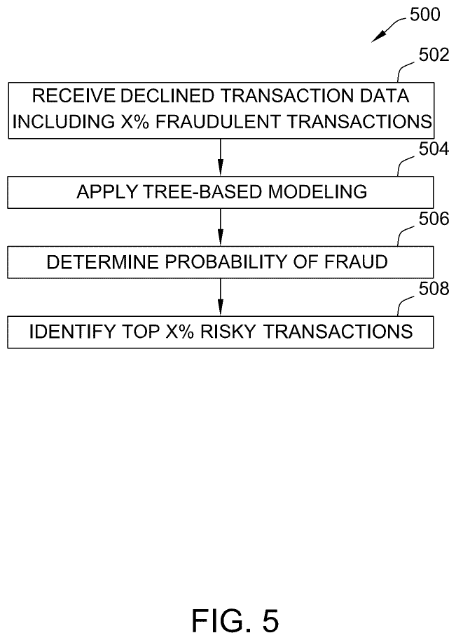

Accordingly, exemplary methods and systems as described in the present disclosure with reference to FIG. 5 may be used to identify fraudulent transactions from the declined transactions to improve approval of genuine financial transactions while declining transactions that are fraudulent transactions.

Multi-party payment processing network system 100 also includes off-network marketplace 108. In the example embodiment, any of the in-network entities may register for marketplace enrichment operations provided by one or more off-network marketplace providers 108 that may be separate and distinct from any of the in-network entities included in the home payment network.

As used herein, the marketplace 108 may refer to a party that is outside of or separate from a home payment network that provides enrichment services outside of the home network or that is different from in-network entities of the home payment network where the payment card transaction is originated. As used herein, off-network third party marketplace 108 or ecosystem providers are capable of receiving marketplace operation requests from one or more home entities within the home payment network and providing and/or applying marketplace enrichment operations for payment card transactions originating in the home payment network by home entities who registered for the marketplace operations. The marketplace provider 108 may apply the marketplace enrichment operation to the payment transaction. The term applying, as it relates to a marketplace operation, is a generic term describing execution of the marketplace operation or execution of further enrichment processing of the transaction message that provides additional value-added services to the requestor and/or the cardholder. For example, applying a marketplace operation may refer to enriching data contained within the payment transaction, such as adding additional data to the transaction message. In another example, applying a marketplace operation may refer to providing insurance coverage for an amount (full or partial) of the payment transaction in the event that the payment transaction is later determined to be fraudulent or if for some reason the merchant is unable to provide the product or service purchased. In some embodiments, the off-network marketplace providers 108 are not financial institutions. The off-network marketplace providers 108 may include, without limitation, a sales tax compliance institution, a duty tax compliance institution, a fintech institution, a receipt institution, a loyalty installment institution, a fraud detection institution, an insurance provider, or any suitable entity enabled to provide a marketplace operation to a payment transaction.

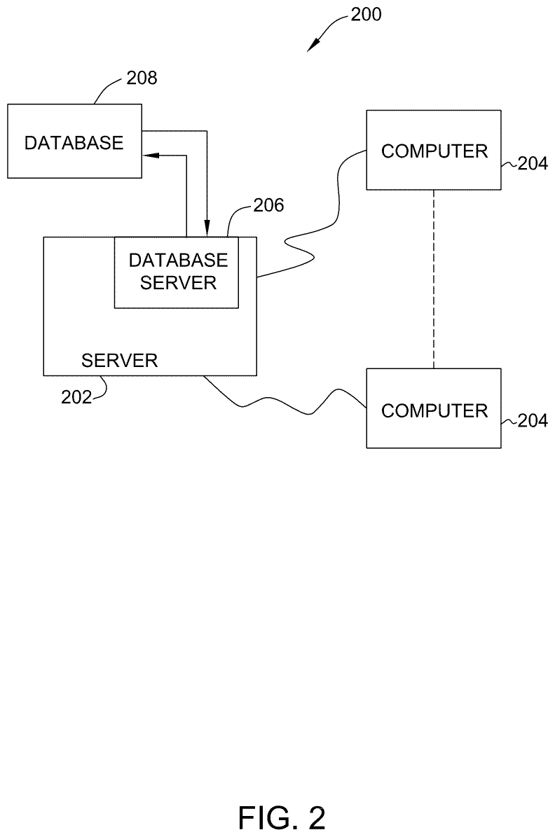

FIG. 2 is a simplified block diagram of an example computer system 200 representative of the interchange network 110 in multi-party payment processing network system 100 (shown in FIG. 1). In the example embodiment, system 200 includes a server system 202 and a plurality of client subsystems, also referred to as client systems 204, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. In any alternative embodiment, database 208 is stored remotely from server system 202 and may be non-centralized.

As discussed below, payment card information including account numbers, payment card numbers, expiration dates, and account statuses, such as whether the account is open or closed, is stored within database 208. Further, data relating to the cardholder of a payment card and payment transaction data may also be stored within database 208. Such cardholder data may include, for example, cardholder name and cardholder billing address. Transaction details including authorization requests and statuses for the authorization requests including authorization codes and/or reasons codes for declining the authorization requests may also be stored within database 208.

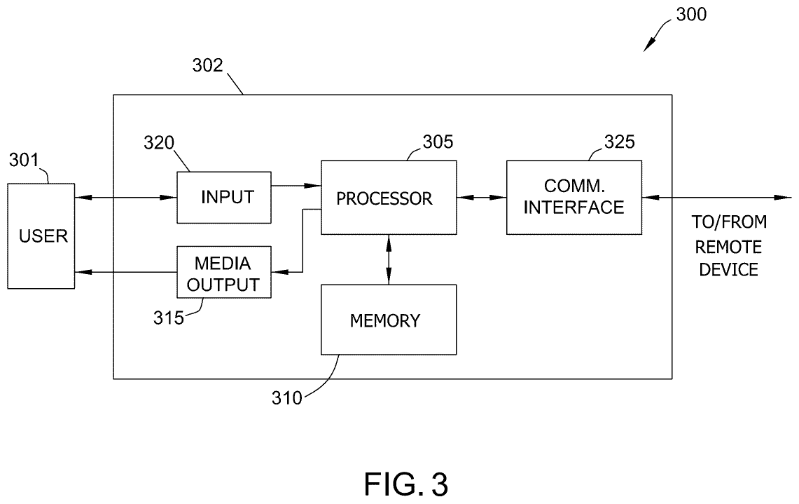

FIG. 3 illustrates an example configuration 300 of a cardholder or user computer system 302 operated by a user (e.g., cardholder) 301. Cardholder computer system 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or other data to be stored and retrieved. Memory area 310 may include one or more computer readable media.

Cardholder computer system 302 also includes at least one media output component 315 for presenting information to cardholder 301. Media output component 315 is any component capable of conveying information to cardholder 301. In some embodiments, media output component 315 includes an output adapter such as a video adapter and/or an audio adapter. An output adapter is operatively coupled to processor 305 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computer system 302 includes an input device 320 for receiving input from cardholder 301. Input device 320 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 315 and input device 320.

Cardholder computer system 302 may also include a communication interface 325, which is communicatively couplable to a remote device such as server system 202 or a web server operated by a merchant. Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 310 are, for example, computer readable instructions for providing a user interface to cardholder 301 via media output component 315 and, optionally, receiving and processing input from input device 320. A user interface may include, among other possibilities, a web browser and client application. Web browsers enable cardholders, such as cardholder 301, to display and interact with media and other information typically embedded on a web page or a website from server system 202 or a web server associated with a merchant. A client application allows cardholder 301 to interact with a server application from server system 202 or a web server associated with a merchant.

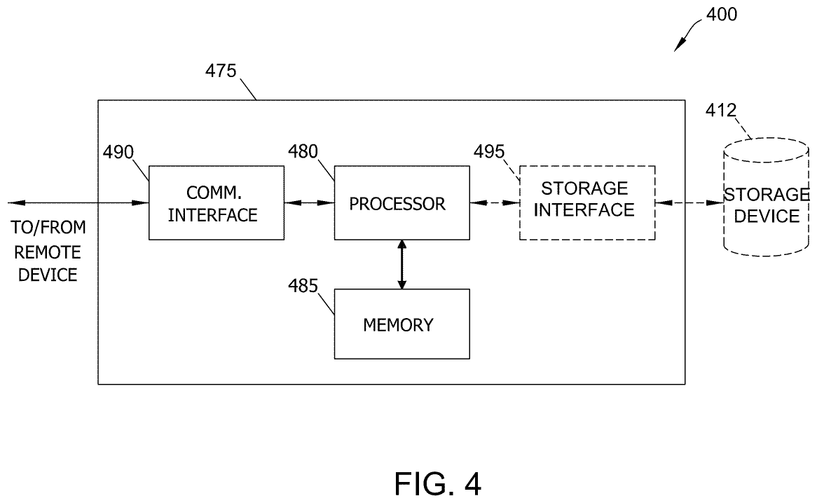

FIG. 4 illustrates an example configuration 400 of a server computer system 475 such as server system 202 (shown in FIG. 2) or interchange network 110 (shown in FIG. 1). Server computer system 475 may include, but is not limited to, database server 206.

Server computer system 475 includes a processor 480 for executing instructions. Instructions may be stored in a memory area 485, for example. Processor 480 may include one or more processing units (e.g., in a multi-core configuration).

Processor 480 is operatively coupled to a communication interface 490 such that server computer system 475 is capable of communicating with a remote device such as cardholder computer system 302 (shown in FIG. 3) or another server computer system 475. For example, communication interface 490 may receive requests from client systems 204 via the Internet, as illustrated in FIG. 2.

Processor 480 may also be operatively coupled to a storage device 412. Storage device 412 is any computer-operated hardware suitable for storing and/or retrieving data. In some embodiments, storage device 412 is integrated in server computer system 475. For example, server computer system 475 may include one or more hard disk drives as storage device 412. In other embodiments, storage device 412 is external to server computer system 475 and may be accessed by a plurality of server computer systems 475. For example, storage device 412 may include multiple storage units such as hard disks or solid-state disks in a redundant array of inexpensive disks (RAID) configuration. Storage device 412 may include a storage area network (SAN) and/or a network attached storage (NAS) system.

In some embodiments, processor 480 is operatively coupled to storage device 412 via a storage interface 495. Storage interface 495 is any component capable of providing processor 480 with access to storage device 412. Storage interface 495 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 480 with access to storage device 412.

Memory area 485 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only and are thus not limiting as to the types of memory usable for storage of a computer program.

FIG. 5 is an example flow diagram 500 illustrating precision labeling of transaction data using tree-based models. As shown in the flow diagram 500, a batch of transaction data including declined transactions with a particular number or percentage X of fraudulent transactions included therein may be received 502 by the processing system described herein. By way of a non-limiting example, transaction data may include millions of transactions, for example, 70 million or more transactions may be included. From the received millions of transactions, a certain number of transactions may be known to be fraudulent transactions based on historical data that has been captured. For example, from the received 70 million transactions, 109,000 transactions may be fraudulent transactions. In other words, the received transaction data may have an event rate X as 0.155% (109,000/70,000,000×100) for fraudulent transactions.

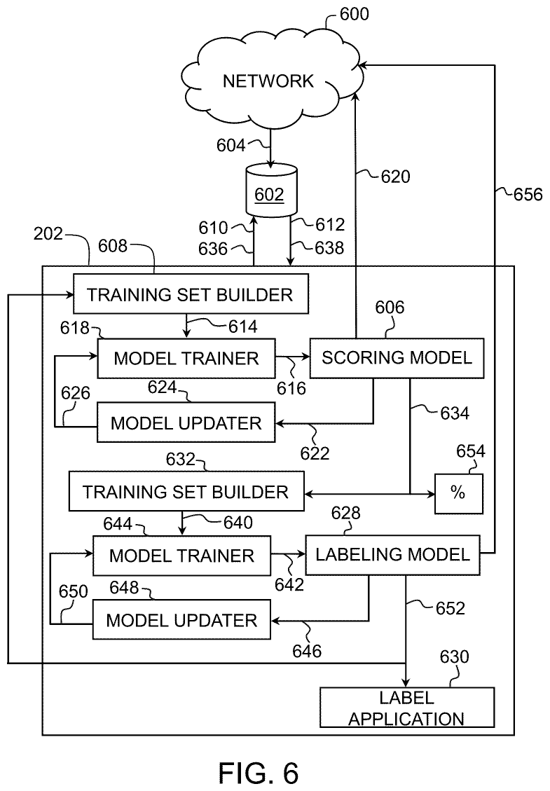

As shown further in the flow diagram 500, one or more machine learning (ML) tree-based models trained, as described herein using FIG. 6, may be used for applying 504 data modeling. By way of a non-limiting example, the one or more ML models may be tree-based models, such as extreme gradient boosting (XGB) based decision trees, which are trained using data of declined transactions including fraudulent and/or non-fraudulent transactions. In some embodiments, the data used for training the ML models may be collected over a 1 year period of time or some other period of time. However, data collected over more than 1 year or less than 1 year may also be used for training the ML models.

In some embodiments, using the one or more ML models trained using the data in which a total number of fraudulent transactions is known, a probability of fraud for each transaction may be determined 506 using the one or more ML models. The probability of fraud may be determined based upon a probability score that is determined using baseline features and a plurality of fraud detection models. The fraud detection models may be determined or identified using a combination of various attributes of a transaction. By way of a non-limiting example, a card number, a merchant category code (MCC), a merchant name, and/or other merchant details, and so on, may be combined to determine or identify fraud detection models to be applied. Additionally, or alternatively, an authorized amount, a number of declined transactions, an exception-based reporting (XBR) count of transactions, and/or an XBR sum, and so on, may be combined to determine or identify the fraud detection models to be used. Furthermore, attributes of transactions over different time periods, such as 15 minutes, 1 hour, 1 day, 1 week, 8 weeks, and so on, may be used to determine or identify the fraud detection models. In one example, a total number of fraud detection models that may be identified are in the 100s.

In some embodiments, once a transaction is identified or labeled as a fraudulent transaction, associated transactions that occur in the future (e.g., next 15 minutes, 1 hour, and/or 12 hours, of the declined and fraudulent transaction) may be reviewed. Accordingly, using the transactions that occurred after a fraudulent transaction is identified-a concept which is referred to as using forward velocities-more transactions that are fraudulent may be identified. In other words, using the forward velocities concept, the precision of identifying fraudulent transactions may be increased. By way of a non-limiting example, for the fraud detection models, a plurality of forward velocities features (e.g., more than 200 or so) may be considered. Using forward velocities features in combination with the fraud detection models, it has been discovered that an increase in precision to about 25% to 50% may be obtained.

As further shown in the flow diagram 500, a top X % of transactions based on the probability score may be identified 508 as likely fraudulent transactions. However, as described herein, a higher precision may be obtained when the probability score is generated for transactions in baches of total number of known fraudulent transactions divided by a predetermined number of batches. By way of a non-limiting example, the predetermined number of batches may be 1 to n, where n may be 10 or more. A higher value of n may further improve precision in identifying fraudulent transactions. Accordingly, in one example, in comparison with the DLL based rules system, where precision in identifying fraudulent transactions is about 15%, precision in identifying fraudulent transactions from about 25% to 50% may be achieved using one or more ML models using fraud detection models and forward velocities features. The batches or subsets of a larger set of the declined transactions may be scored using a labeling model to identify transactions within the subset as fraudulent. If done over several subsets of data, it can then be determined which subset of data produces the highest level of accuracy for the labeling model. This subset of data may then be used for re-training of the scoring model.

A comparison of the new system and method described herein that includes the ML trained model using the XGB based decision trees with forward velocities to the DLL based rules system shows that when an ML model trained using the XGB based decision trees is used for the received transaction data including about 70 million transactions and 109,000 fraudulent transactions, the precision in identifying fraudulent transactions is improved to about 25% to 50% using the one or more ML models using fraud detection models and forward velocities features. Whereas, the known approach of using the DLL rule based system provides a precision of about 15%. Therefore, as described and shown herein, the ML derived model has been shown to be more potent and accurate than the rule-based systems. The ML model is significantly easier to refresh than the rule-based systems, and no experts are needed to refresh the ML model whereas they are needed in the rule-based systems. The probabilistic score from the ML model offers more flexibility as compared to the binary label of the rule-based approach. With respect to the concept of forward velocities, it has been discovered that at the same recall value, forward velocities created within just 12 hours, improves the precision of detection by (i) a large margin compared to ML baseline (approximately 9.3×), and (ii) as well as compared to existing DLL rule-based systems (approximately 3.3×).

FIG. 6 is a schematic diagram illustrating further detail of exemplary server computing device 202 (shown in FIG. 2). Server computing device 202 may communicate with other components of system 200, such as database server 206 (or a third-party server), client systems 204 via a network 600. Server computing device 202 may include and/or be in communication with a database 602 that stores data 604 including transaction data. Data 604 received from network 600 may be stored in database 602. Server computing device 202 may be configured to use data 604 to generate a scoring model module 606 for generating and providing a scoring model for controlling operations of the server computing device 202 (e.g., in accessing third-party databases via a digital portal), predicting fraudulent transactions, generating action recommendations in response to operational requests, and the like.

In exemplary embodiments, server computing device 202 includes a training set builder module 608 configured to submit one or more queries 610 to database 602 to retrieve subsets 612 of data 604, and to use those subsets 612 to build training data sets 614 for generating the scoring model via the machine-learning scoring model module 606. For example, query 610 may be configured to retrieve certain fields from data 604 for historical claims sharing characteristics, transactions originated by certain POS or merchants, transaction history for a customer, and the like.

In exemplary embodiments, training set builder module 608 may be configured to derive training data sets 614 from retrieved subsets 612. Each training data set 614 corresponds to a historical data 604 (“historical” in this context means completed in the past, as opposed to completed in real-time with respect to the time of retrieval by training set builder module 608). Each training data set 614 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 614 may be generated from data fields in subset 612 corresponding to historical data 604. In other words, a trained machine learning model 616 produced by a model trainer module 618 for use by scoring model module 606 is trained to make predictions based on input values that can be generated from the data fields in data 604. Values in the model input data fields may include values copied directly from values in a corresponding data field in the retrieved subset 612, and/or values generated by modifying, combining, or otherwise operating upon values in one or more data fields in the retrieved subset 612. The use of such data fields as model input data fields facilitates the machine learning model in weighing these factors directly.

After training set builder module 608 generates training data sets 614, training set builder module 608 passes the training data sets 614 to model trainer module 618. In example embodiments, model trainer module 618 is configured to apply the model input data fields of each training data set 614 as inputs to one or more machine learning models. Each of the one or more machine learning models is programmed to produce, for each training data set 614, at least one output intended to correspond to, or “predict,” a value of the at least one result data field of the training data set 614. “Machine learning” refers broadly to various algorithms that may be used to train the model to identify and recognize patterns in existing data in order to facilitate making predictions for subsequent new input data.

Model trainer module 618 is configured to compare, for each training data set 614, the at least one output of the model to the at least one result data field of the training data set 614, and apply a machine learning algorithm to adjust parameters of the model in order to reduce the difference or “error” between the at least one output and the corresponding at least one result data field. In this way, model trainer module 618 trains the machine learning model to accurately predict the value of the at least one result data field. In other words, model trainer module 618 cycles the one or more machine learning models through the training data sets 614, causing adjustments in the model parameters, until the error between the at least one output and the at least one result data field falls below a suitable threshold, and then uploads at least one trained machine learning model 616 to scoring model module 606 for application in generating recommendations 620. In exemplary embodiments, model trainer module 618 may be configured to simultaneously train multiple candidate machine learning models and to select the best performing candidate for each result data field, as measured by the “error” between the at least one output and the corresponding result data field, to upload to scoring model module 606.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 618 cycles through the training data sets 614, model trainer module 618 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 618 provides an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

The server computing device 202 of the present disclosure is configured to operate on input data related to financial transactions, access additional data, and generate labels identifying fraudulent and non-fraudulent transactions. In one exemplary embodiment, the server computing device 202 executes the scoring model module 606 programmed to learn, without limitation, outcomes of transactions' labeling based upon varying events and details, relevant data sources for evidence, the queries used to prompt a user to provide relevant information, features of financial transactions related to potential fraud, and the like.

To facilitate this learning, the server computing device 202 includes one or more databases 602 at which the data, including requests, responses, feature codes, evidence, outcomes, etc., is stored. This data becomes one or more input training sets used by the training set builder 608. Model outputs can be formatted for presentation or review as visual representations of recommendations, as text-based or natural language recommendations, and the like. In exemplary embodiments, scoring model module 606 may compare feedback, and may route a comparison result 622 generated by comparing recommendation 620 to the feedback to a model updater module 624 of the server computing device 202. Model updater module 624 is configured to derive a correction signal 626 from comparison results 622 received for one or more recommendations and to provide correction signal 626 to model trainer module 618 to enable updating or “re-training” of the at least one machine learning model to improve performance. The retrained at least one machine learning model 616 may be periodically re-uploaded to scoring model module 606.

Server computing device 202 may also be configured to use data 604 and/or an output from scoring model module 606 to generate and/or be used in association with (i) a labeling model module 628 for generating and providing a labeling model for controlling labeling operations of the server computing device 202, labeling fraudulent transactions, generating action recommendations in response to operational requests, and the like, and (ii) a label application module 630 to apply the labels generated by labeling model module 628 to (fraudulent) transactions.

In exemplary embodiments, server computing device 202 includes a training set builder module 632 that is configured to interface with scoring model module 606 to receive an output 634 from scoring model module 606, and to submit one or more queries 636 to database 602 to retrieve subsets 638 of data 604, and to use those subsets 638 to build training data sets 640 for generating a labeling model via labeling model module 628. Output 634 may include, for example, the latest parameters of the latest scoring model. For example, query 636 may be configured to retrieve certain fields from data 604 for historical data including past fraudulent transactions and characteristics of such, including fraud data originated by certain POS or merchants, transaction history for a customer, and the like.

In exemplary embodiments, training set builder module 632 may be configured to derive training data sets 640 from retrieved subsets 638. Each training data set 640 corresponds to a historical data 604 (“historical” in this context means completed in the past, as opposed to completed in real-time with respect to the time of retrieval by training set builder module 632, and may also correspond to information within output 634 from scoring model module 606, where the output 634 from scoring model module 606 provides training set builder module 632 with the latest scoring parameters of the scoring model so that the training set builder module 632 can more accurately train the label model to label fraudulent transactions). In other words, scoring model module 606 and labeling model module 628 may have a working (e.g., symbiotic) relationship where scoring model module 606 feeds training set builder module 632 of labeling model module 628 so that each model learns and grows over time to better determine, predict, and label fraud. Additionally, or alternatively, labeling model module 628 may be configured to feed scoring model module 606, where an on output (e.g., output 652) from labeling model module 628 may be fed into scoring model module 606 (e.g., via training set builder 608) so that scoring model module 606 operates according to the latest parameters of labeling model module 628. Each training data set 640 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 640 may be generated from data fields in subset 638 corresponding to historical data 604. In other words, a trained machine learning model 642 produced by a model trainer module 644 for use by labeling model module 628 is trained to make predictions based on input values that can be generated from the data fields in data 604. Values in the model input data fields may include values copied directly from values in a corresponding data field in the retrieved subset 638, and/or values generated by modifying, combining, or otherwise operating upon values in one or more data fields in the retrieved subset 638. The use of such data fields as model input data fields facilitates the machine learning model in weighing these factors directly.

After training set builder module 632 generates training data sets 640, training set builder module 632 passes the training data sets 640 to model trainer module 644. In example embodiments, model trainer module 644 is configured to apply the model input data fields of each training data set 640 as inputs to one or more machine learning models, such as labeling model module 628. Each of the one or more machine learning models is programmed to produce, for each training data set 640, at least one output intended to correspond to, or “predict,” a value of the at least one result data field of the training data set 640. “Machine learning” refers broadly to various algorithms that may be used to train the model to identify and recognize patterns in existing data in order to facilitate making predictions for subsequent new input data.

Model trainer module 644 is configured to compare, for each training data set 640, the at least one output of the model to the at least one result data field of the training data set 640, and apply a machine learning algorithm to adjust parameters of the model in order to reduce the difference or “error” between the at least one output and the corresponding at least one result data field. In this way, model trainer module 644 trains the machine learning model to accurately predict the value of the at least one result data field. In other words, model trainer module 644 cycles the one or more machine learning models through the training data sets 640, causing adjustments in the model parameters, until the error between the at least one output and the at least one result data field falls below a suitable threshold, and then uploads at least one trained machine learning model 642 to labeling model module 628 for application in generating recommendations 656. In exemplary embodiments, model trainer module 644 may be configured to simultaneously train multiple candidate machine learning models and to select the best performing candidate for each result data field, as measured by the “error” between the at least one output and the corresponding result data field, to upload to labeling model module 628.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 644 cycles through the training data sets 640, model trainer module 644 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 644 provides an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

The server computing device 202 of the present disclosure is configured to operate on input data related to financial transactions, access additional data, and generate labels identifying fraudulent and non-fraudulent transactions. In one exemplary embodiment, the server computing device 202 executes the scoring model module 606 and the labelling model module 628 programmed to learn, without limitation, outcomes of transactions' labeling based upon varying events and details, relevant data sources for evidence, the queries used to prompt a user to provide relevant information, features of financial transactions related to potential fraud (e.g., labels), and the like.

To facilitate this learning, the server computing device 202 includes one or more databases 602 at which the data, including requests, responses, feature codes, evidence, outcomes, etc., is stored. This data becomes one or more input training sets used by the training set builder 632. Model outputs can be formatted for presentation or review as visual representations of recommendations, as text-based or natural language recommendations, and the like. In exemplary embodiments, labeling model module 628 may compare feedback, and may route a comparison result 646 generated by comparing recommendation to the feedback to a model updater module 648 of the server computing device 202. Model updater module 648 is configured to derive a correction signal 650 from comparison results 646 received for one or more recommendations and to provide correction signal 650 to model trainer module 644 to enable updating or “re-training” of the at least one machine learning model to improve performance. The retrained at least one machine learning model 642 may be periodically re-uploaded to labeling model module 628. Labeling model module 628 may interface via output 652 with label application module 630 so that labels can be applied by label application module 630 to fraudulent transactions using the most updated model and model parameters via output 652. Beyond sharing the potential to share output 634 with labeling model module 628 and share output 652 with scoring model module 606, other aspects of the two models may be shared with respect to the interfacing of the two models together, including but not limited to sharing of trained learning models 616, 642 and comparison results 622, 646 between the models (or any other aspects of the models shown in FIG. 6, such as correction signals 626, 650). Output 634 from scoring model module 606 may be utilized by and with a precision percentage generator module 654 configured to generate precision percentages. The scoring model and the labeling model may be referred to individually as separate machine learning modules, or as being within a machine learning module (e.g., the machine learning module includes both the scoring model and the labeling model).

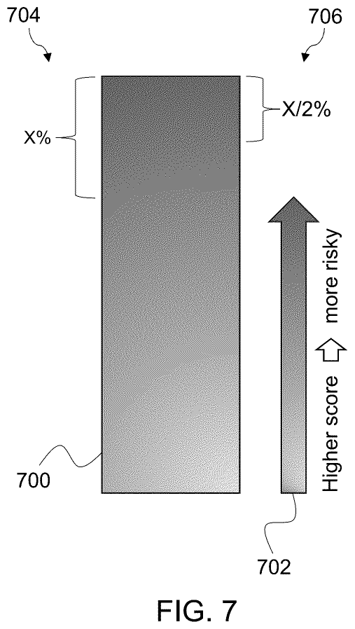

FIG. 7 is a diagram illustrating a risk gradient for a set of declined transactions that have been scored by a model with the score indicating the likelihood of fraud of each tarnation. FIG. 7 shows a data set 700, where the higher a score from the scoring model is, the more likely the transaction is deemed fraud, as illustrated by the coloration of the gradient intensity scale 702 (where darker=more risky, lighter=less risky). Precision of determining fraudulent transactions by way of the ML models, forward velocities, and labeling techniques described herein may increase as the transaction data is cut into smaller and smaller subsets (which may be referred to as “cuts”), where a precision percentage of the labeling model correctly identifying a transaction as fraudulent increases when the subset of the higher scored transactions are made (Precision (X%) is less fo subset 1 as compared to Precision (X %) for subset 2 and so on and so forth, up to Precision(X %) for subset n) This is represented in part by X % portion 704 and X/2 portion 706 shown in FIG. 7, where the cut of portion 706 is smaller than that of portion 704 (and the gradient of portion 706 is darker than that of portion 704, representing more risky transactions).

For example, in one example of a test run of cuts on a set of transaction data where forward velocities were applied to the set, a first cut of the transaction data may result in a subset of 109,331 potential fraudulent transaction, where within this subset, 27,384 transactions where actually determined to be fraudulent by the labeling model, resulting in a 25.047% precision percentage (e.g., in FIG. 7, X % portion 704 would be 25.047%). Any subsequent cut (or subset of x portion) results in an increase in precision percentage. For example, a next cut in the above example may represent a roughly 50% smaller subset than the first cut, with the second cut (e.g., X/2 (portion 706)) including a subset of 54,665 potential fraudulent transactions labeled by labeling model, where within this subset 18,289 transactions where actually determined to be fraud, resulting in a 33.457% precision percentage (e.g., in FIG. 7, the X/2 portion 706 would be 33.457%). For example, carrying out 10 cuts in the example above, a subset of 10,933 potential fraudulent transactions (e.g., roughly 1/10 of the 109,331 potential fraudulent transactions of the first cut) may result in 5,362 transactions within this subset being determined to be fraud, resulting in a 49.044% precision (an X/10 portion is not shown in FIG. 7, but would be represented an even smaller sliver of the transactions of data set 700 than the X/2 portion 706).

This represents just one non-limiting example of the application of forward velocities to data sets, and the improvements yielded by using the forward velocities. As described herein, with respect to the concept of forward velocities, it has been discovered that at the same recall value, forward velocities created within just 12 hours, improves the precision of detection by (i) a large margin compared to ML baseline (approximately 9.3×), and (ii) as well as compared to existing DLL rule-based systems (approximately 3.3×). Output 634 from scoring model module 606 may be utilized by and with a precision percentage generator module 654 to generate such precision percentages for use within the system, as described herein. For example, a selected subset of declined transactions having a highest precision percentage may be used as a re-training subset for re-training the scoring model.

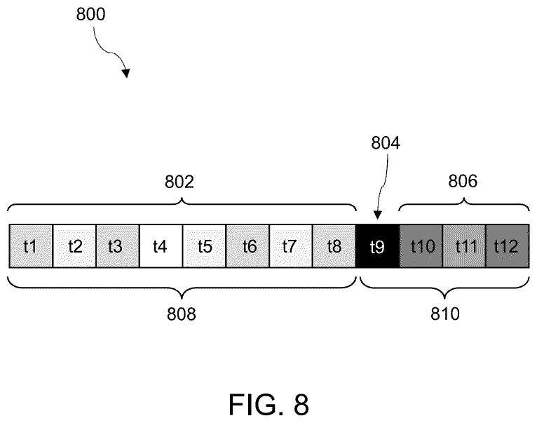

FIG. 8 is a diagram illustrating a timeline 800 of transactions initiated using a payment card. Timeline 800 illustrates a color-coded depiction of transactions that represent an example of normal (e.g., non-fraudulent) transactions, as well as an example of transactions labeled/declined as fraud and/or suspected fraud. Transactions 802 (e.g., transactions t1 to t8, represented by lighter-colored blocks in FIG. 8) are representative of normal (e.g., non-fraudulent) transactions that were processed in the normal course of usage by a cardholder using a payment card. Transaction 804 (e.g., transaction t9, represented by the darkest-colored block in FIG. 8) illustrates a transaction that was declined as potentially fraud. Subsequent transactions 806 (e.g., transactions t10 to t12, represented by blocks with colors darker than those of the blocks representing transactions 802 in FIG. 8) are treated as associated fraudulent transactions (or retries) since they occur after fraudulent transaction 804. For example, the system may know/learn that a cardholder may routinely/repeatedly make certain purchases over a certain period of time, where time period 808 may represent a frequency of normal transactions (e.g., transactions 802, which includes transactions t1 through t8) made over the course of a normal time period (e.g., time period 808 may have a duration of one week)). However, after (fraudulent) transaction 804 occurs, subsequent transactions 806 may take place in quick succession, where time period 810 may represent just a few minutes in total time (e.g., a few minutes pass between transaction t9 (transaction 804) and transaction t12 (of transactions 806)).

In this scenario, normal usage includes eight transactions (transactions t1 to t8 of transactions 802) over the course of a week (e.g., time period 808), whereas transactions t9 to t12 (of transactions 804 and 806) take place over a span of minutes (e.g., time period 810). The transactions 804 and 806 occurring within time period 810, and the duration of time period 810 itself, is/are uncharacteristic of the cardholder's normal usage (e.g., in comparison to the transactions 802 within time period 808 and the duration of time period 808 itself), and therefore transactions 806 are highly likely to be fraudulent. In the real world, a bad actor may obtain access to a credit card of a cardholder, and make a first fraudulent transaction (e.g., transaction 804). The bad actor may know that it is in a race against time to make more (e.g., fraudulent) transactions before the credit card is locked and unable to be used again, and therefore makes a series of quick, additional transactions (e.g., transactions 806, wherein transactions t10, t11, and t12 may occur within minutes of each other of transaction 804). The ML models, forward velocities, and labeling techniques described herein assist in being able to better detect and label instances such as in the example above, which then improves the quality of detection and labeling going forward as the ML models are updated and learn/improve over time. For example, the plurality of forward velocity features may correspond with attributes of transactions 806 that occur after a specific period of a declined transaction 804 that is labeled as a fraudulent transaction.

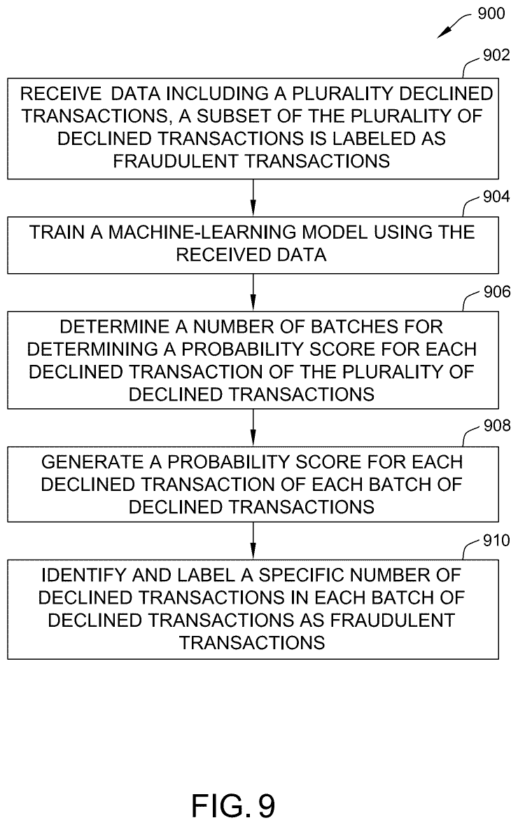

FIG. 9 is a flow diagram of an example method 900 of identifying fraudulent transactions from the declined transaction using one or more ML algorithms (or models) that are more powerful (or potent) over the known DLL based rules system for identifying fraud patterns from the declined transactions that are labeled as fraudulent transactions. As described herein, using the one or more ML models, a need for a human intervention (or an expert) defining the rules of the DLL based rules system may be avoided, and any updates in response to a new fraud pattern may be implemented more efficiently. Further, a probability score may be generated by the one or more ML models regarding how likely a declined transaction is a fraudulent transaction. Based on the probability score, more declined transactions may be determined or identified as fraudulent transactions, which would increase the precision of identifying fraudulent transactions.

In some embodiments, the method 900 may include receiving 902 data associated with a plurality of declined transactions. The data may be received by or from the interchange network 110 from the issuer 112. The plurality of declined transactions may include a subset of declined transactions being labeled as fraudulent transactions by the issuer 112.

In some embodiments, the method 900 may further include training 904 one or more ML models using the received data by the interchange network 110 from the issuer 112. By way of a non-limiting example, the one or more ML models may be tree-based models, such as extreme gradient boosting (XGB) based decision trees, which are trained using data associated with declined transactions including fraudulent and/or non-fraudulent transactions. In some embodiments, the data used for training the ML models may be collected over 1 year period of time. However, data collected over more than 1 year or less than 1 year may also be used for training the ML models.

In some embodiments, using the one or more ML models trained using the data in which a total number of fraudulent transactions is known, a probability score for each declined transaction may be determined using the one or more ML models. The probability score may be determined using baseline features and a plurality of fraud detection models. The fraud detection models may be determined or identified using a combination of various attributes of a transaction. By way of a non-limiting example, a card number, a merchant category code (MCC), a merchant name, and/or other merchant details, and so on, may be combined to determine or identify fraud detection models to be used for generating an output. Additionally, or alternatively, an authorized amount, a number of declined transactions, an exception-based reporting (XBR) count of transactions, and/or an XBR sum, and so on, may be combined to determine or identify the fraud detection models to be used for generating an output such as a fraud score. Further, attributes of transactions over different time periods, such as 15 minutes, 1 hour, 1 day, 1 week, 8 weeks, and so on, may be used to determine or identify the fraud detection models to be used. In one example, a total number of fraud detection models that may be identified may be in the 100s.

In some embodiments, once a transaction is declined and identified or labeled as a fraudulent transaction, associated transactions that occur in the future (e.g., next 15 minutes, 1 hour, and/or 12 hours, of the declined and fraudulent transaction) may be reviewed. Accordingly, using the declined transactions that occurred after a fraudulent transaction is identified-- a concept which is referred to as using forward velocities-more transactions that are fraudulent may be identified. In other words, using the forward velocities concept, the precision of identifying fraudulent transactions may be increased. By way of a non-limiting example, for the fraud detection models discussed herein, about 290 forward velocity features may be used to further identify fraudulent transactions. Using forward velocities features in combination with the fraud detection models, a precision of fraud detection of about 25% to 50% may be obtained.

In some embodiments, a number of batches of declined transactions may be determined 906 for determining a probability score for each declined transaction of the plurality of declined transactions. In particular, higher precision may be obtained when the probability score is generated for transactions in baches having a total number of known fraudulent transactions divided by a predetermined number of batches. By way of a non-limiting example, the predetermined number of batches may be 1 to n, where n may be 10 or more. A higher value of n may further improve precision in identifying fraudulent transactions. Accordingly, in comparison with the DLL based rules system, where precision in identifying fraudulent transactions is about 15%, precision in identifying fraudulent transactions of about 25% to 50% may be achieved using the one or more ML models using fraud detection models and forward velocity features as described herein.

In some embodiments, a probability score may be generated 908 for each declined transaction of each batch of declined transactions. As described herein, the probability score for each declined transaction may be determined using the one or more ML models. The probability score may be determined using baseline features and a plurality of fraud detection models. The fraud detection models may be determined or identified using a combination of various attributes of a transaction. By way of a non-limiting example, a card number, a merchant category code (MCC), a merchant name, and/or other merchant details, and so on, may be combined to determine or identify fraud detection models that are used to generate and output such as a fraud score for the transaction. Additionally, or alternatively, an authorized amount, a number of declined transactions, an exception-based reporting (XBR) count of transactions, and/or an XBR sum, and so on, may be combined to determine or identify the fraud detection models used. Further, attributes of transactions over different time periods, such as 15 minutes, 1 hour, 1 day, 1 week, 8 weeks, and so on, may be used to determine or identify the fraud detection models used. In one example, a total number of fraud detection models that may be identified may be in the 100s.

In some embodiments, based on the probability score for each declined transaction of each batch of declined transactions, a specific number of declined transactions in each batch of declined transaction may be identified and labeled 910 as fraudulent transactions. The specific number of declined transactions may correspond with a number of fraudulent transactions in the subset of the plurality of declined transactions and the number of batches. For example, the if the number of fraudulent transactions in the subset of the plurality of declined transactions is 100,000 and the number of batches is 10, then the specific number of declined transactions in each batch may be 100,000/10 (or 10,000).

After identifying the fraudulent transactions within a set of declined transactions, this newly labeled data may be used to build or update fraud detection models for future use on transactions being processed over a payment network. In other words, by labeling these declined transactions as fraudulent and/or non-fraudulent, this labeled data may be used to help build improved AI/ML models for identifying fraud within newly processed transactions. Thus, the ability to precisely label this data helps to produce improved fraud models for later use.

This written description uses examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for labeling anomalous data for re-training a scoring machine-learning model, the computer system comprising:
a machine learning module comprising a labeling model for analyzing and labeling data;
a memory for storing computer-executable instructions; and
at least one processor in communication with the memory and the machine learning module, when the computer-executable instructions are executed, the at least one processor is programmed to:
receive transaction data associated with a plurality of declined transactions, at least some of the plurality of declined transactions being labeled as fraudulent;
apply a scoring model to the transaction data for the plurality of declined transactions, the scoring model outputting a probability score for each declined transaction indicating a likelihood that the corresponding declined transaction is fraudulent;
rank the plurality of declined transactions using the probability scores from low probability of fraud to high probability of fraud;
apply the labeling model to the transaction data of a set of the plurality of declined transactions, the set including a batch of the declined transactions having higher probability scores assigned thereto as compared to the remainder of the plurality of declined transactions;
generate, using the labeling model, a precision percentage for the set of the plurality of declined transactions, the precision percentage representing a ratio of the declined transactions labeled as fraud by the labeling model relative to the total number of declined transactions included in the set of declined transactions;
identify one or more subsets of declined transactions within the set of declined transactions;
generate a precision percentage for each of the one or more subsets of declined transactions;
select the subset of the set of declined transactions having the highest corresponding precision percentage assigned thereto; and
identify the selected subset of declined transactions as a re-training subset of fraudulent transactions for re-training the scoring model.

2. The computer system of claim 1, wherein the instructions further cause the at least one processor to apply the labeling model to the transaction data of a set of the plurality of declined transactions, wherein the labeling model is trained using historical transaction data for a plurality of account identifiers included in the plurality of declined transactions, wherein the transaction data for each account identifier of a declined transaction includes transaction data associated with a plurality of transactions initiated prior to the declined transaction and a plurality of transactions subsequent to the declined transactions.

3. The computer system of claim 2, wherein the transaction data associated with a plurality of transactions initiated prior to the declined transaction includes prior transaction velocities including decision intelligence scoring data.

4. The computer system of claim 2, wherein the transaction data associated with a plurality of transactions initiated subsequent to the declined transaction includes forward transaction velocities associated with transactions initiated between 1 minute and 24 hours following the declined transaction.

5. The computer system of claim 1, wherein the instructions cause the at least one processor to train the machine-learning scoring model using at least one of (i) a decision tree approach including extreme gradient boosting (XGB) based decision trees, and (ii) a plurality of forward transaction velocity features.

6. The computer system of claim 1, wherein the instructions cause the at least one processor to generate the probability score using a plurality of fraud detection models and transaction data for each account identifier of a declined transaction including transaction data associated with a plurality of transactions initiated prior to the declined transaction and a plurality of transactions subsequent to the declined transactions.

7. The computer system of claim 6, wherein the plurality of fraud detection models is trained using one or more attributes of declined transactions including transaction level attributes including, but not limited to, an account identifier, a merchant category code (MCC), or a merchant name.

8. The computer system of claim 7, wherein the plurality of fraud detection models is trained using one or more attributes of declined transactions including transaction level attributes including, but not limited to, an authorized amount, or a number of declined transactions.

9. The computer system of claim 6, wherein the transactions initiated subsequent to the decline transactions are initiated between 1 minute and 24 hours after the declined transaction.

10. The computer system of claim 1, wherein the instructions cause the at least one processor to re-train the scoring model using the selected subset of declined transactions labeled as fraudulent transactions to update and improve the accuracy of the scoring model.

11. A computer-implemented method for labeling anomalous data for re-training a scoring machine-learning model, the method comprising:
receiving transaction data associated with a plurality of declined transactions, at least some of the plurality of declined transactions being labeled as fraudulent;
applying a scoring model to the transaction data for the plurality of declined transactions, the scoring model outputting a probability score for each declined transaction indicating a likelihood that the corresponding declined transaction is fraudulent;
ranking the plurality of declined transactions using the probability scores from low probability of fraud to high probability of fraud;
applying a labeling model to the transaction data of a set of the plurality of declined transactions, the set including a batch of the declined transactions having higher probability scores assigned thereto as compared to the remainder of the plurality of declined transactions;
generating, using the labeling model, a precision percentage for the set of the plurality of declined transactions, the precision percentage representing a ratio of the declined transactions labeled as fraud by the labeling model relative to the total number of declined transactions included in the set of declined transactions;
identifying one or more subsets of declined transactions within the set of declined transactions;
generating a precision percentage for each of the one or more subsets of declined transactions;
selecting the subset of the set of declined transactions having the highest corresponding precision percentage assigned thereto; and
identifying the selected subset of declined transactions as a re-training subset of fraudulent transactions for re-training the scoring model.

12. The computer-implemented method of claim 11, further comprising applying the labeling model to the transaction data of a set of the plurality of declined transactions, wherein the labeling model is trained using historical transaction data for a plurality of account identifiers included in the plurality of declined transactions, wherein the transaction data for each account identifier of a declined transaction includes transaction data associated with a plurality of transactions initiated prior to the declined transaction and a plurality of transactions subsequent to the declined transactions.

13. The computer-implemented method of claim 12, wherein the transaction data associated with a plurality of transactions initiated prior to the declined transaction includes prior transaction velocities including decision intelligence scoring data.

14. The computer-implemented method of claim 12, wherein the transaction data associated with a plurality of transactions initiated subsequent to the declined transaction includes forward transaction velocities associated with transactions initiated between 1 minute and 24 hours following the declined transaction.

15. The computer-implemented method of claim 11, further comprising generating the probability score using a plurality of fraud detection models and transaction data for each account identifier of a declined transaction including transaction data associated with a plurality of transactions initiated prior to the declined transaction and a plurality of transactions subsequent to the declined transactions.

16. At least one non-transitory computer-readable storage medium that includes computer-executable instructions embodied thereon that when the computer-executable instructions are executed by at least one processor, the computer-executable instructions cause the at least one processor to:
receive transaction data associated with a plurality of declined transactions, at least some of the plurality of declined transactions being labeled as fraudulent;
apply a scoring model to the transaction data for the plurality of declined transactions, the scoring model outputting a probability score for each declined transaction indicating a likelihood that the corresponding declined transaction is fraudulent;
rank the plurality of declined transactions using the probability scores from low probability of fraud to high probability of fraud;
apply the labeling model to the transaction data of a set of the plurality of declined transactions, the set including a batch of the declined transactions having higher probability scores assigned thereto as compared to the remainder of the plurality of declined transactions;
generate, using the labeling model, a precision percentage for the set of the plurality of declined transactions, the precision percentage representing a ratio of the declined transactions labeled as fraud by the labeling model relative to the total number of declined transactions included in the set of declined transactions;
identify one or more subsets of declined transactions within the set of declined transactions;
generate a precision percentage for each of the one or more subsets of declined transactions;
select the subset of the set of declined transactions having the highest corresponding precision percentage assigned thereto; and
identify the selected subset of declined transactions as a re-training subset of fraudulent transactions for re-training the scoring model.

17. The at least one non-transitory computer-readable storage medium of claim 16, wherein the computer-executable instructions, when executed by the at least one processor, cause the at least one processor to apply the labeling model to the transaction data of a set of the plurality of declined transactions, wherein the labeling model is trained using historical transaction data for a plurality of account identifiers included in the plurality of declined transactions, wherein the transaction data for each account identifier of a declined transaction includes transaction data associated with a plurality of transactions initiated prior to the declined transaction and a plurality of transactions subsequent to the declined transactions.

18. The at least one non-transitory computer-readable storage medium of claim 17, wherein the transaction data associated with a plurality of transactions initiated prior to the declined transaction includes prior transaction velocities including decision intelligence scoring data.

19. The at least one non-transitory computer-readable storage medium of claim 17, wherein the transaction data associated with a plurality of transactions initiated subsequent to the declined transaction includes forward transaction velocities associated with transactions initiated between 1 minute and 24 hours following the declined transaction.

20. The at least one non-transitory computer-readable storage medium of claim 16, wherein the computer-executable instructions, when executed by the at least one processor, cause the at least one processor to generate the probability score using a plurality of fraud detection models and transaction data for each account identifier of a declined transaction including transaction data associated with a plurality of transactions initiated prior to the declined transaction and a plurality of transactions subsequent to the declined transactions.
